(19) United States
(12) Patent Application Publication
(10) Pub. No.: US 2019/0147729 A1
(43) Pub. Date: May 16, 2019

(54) MOBILE DEVICE LOSS PREVENTION DEVICE AND SYSTEM THEREOF

(71) Applicant: Nader Ghazal, Lynnwood, WA (US)

(72) Inventor: Nader Ghazal, Lynnwood, WA (US)

(21) Appl. No.: 15/795,226

(22) Filed: Oct. 26, 2017

(51) Int. Cl. G08B 21/24; H04W 4/02; G08B 3/10; H04W 4/00

(52) U.S. Cl. CPC G08B 21/24; H04W 4/008; G08B 3/10; H04W 4/023

(57) ABSTRACT

A mobile device loss prevention system, including a mobile device, and a mobile device loss prevention device to communicate with the mobile device, comprising a speaker to play a sound in response to the mobile device loss prevention device being moved out of a predetermined range of the mobile device.

### BACKGROUND OF THE INVENTION

### 1. Field of the Invention

The present general inventive concept relates generally to a mobile device loss prevention device.

### 2. Description of the Related Art

In today's society, most people own at least one mobile device, such as a cellular telephone. However, people oftentimes misplace or forget their mobile devices when they are in a rush, thereby losing hundreds of dollars to replace their lost mobile devices.

Therefore, there is a need for a device that prevents people from forgetting and losing their mobile devices.

### SUMMARY

The present general inventive concept provides a mobile device loss prevention device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a mobile device loss prevention system, including a mobile device, and a mobile device loss prevention device to communicate with the mobile device, comprising a speaker to play a sound in response to the mobile device loss prevention device being moved out of a predetermined range of the mobile device.

The speaker may play the sound in response to a BLUETOOTH connection between the mobile device loss prevention device and the mobile device is severed.

The mobile device loss prevention device may further include a sound shut off button to control the speaker to stop playing the sound, and a mobile device finder button to send a signal to the mobile device to control the mobile device to play a sound.

The foregoing and/or other features and utilities of the present general inventive concept may also be achieved by providing a mobile device loss prevention device, including a printed circuit board to allow the mobile device loss prevention to communicate with a mobile device, and a speaker to play a sound in response to the mobile device loss prevention device being moved out of a predetermined range of the mobile device.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 illustrates a mobile device loss prevention system 1, according to an exemplary embodiment of the present general inventive concept;

### DETAILED DESCRIPTION OF THE INVENTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

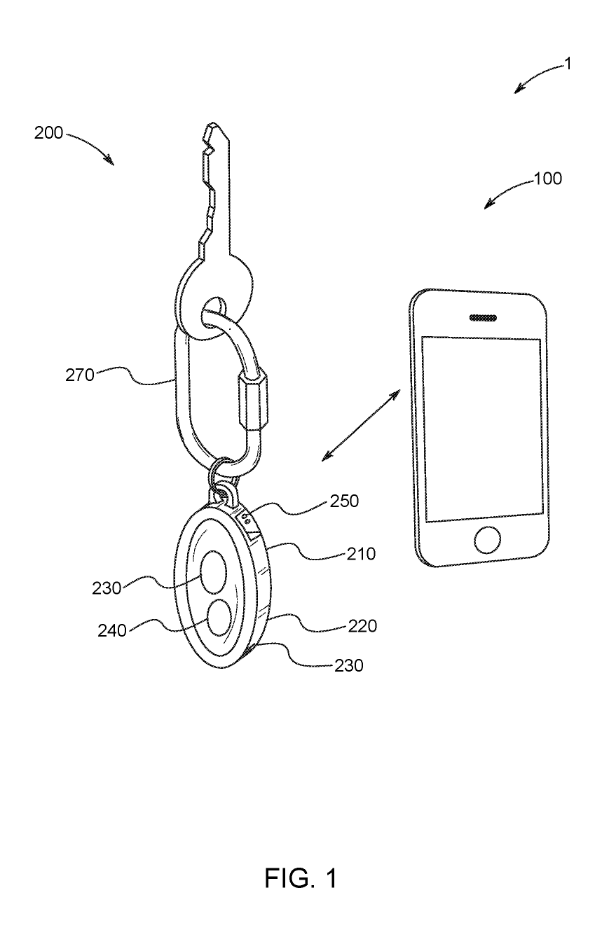

FIG. 1 illustrates a mobile device loss prevention system 1, according to an exemplary embodiment of the present general inventive concept.

Referring to FIG. 1, the mobile device loss prevention system 1 may include a mobile device 100 and a mobile device loss prevention device 200.

The mobile device 100 may be in communication with the mobile device loss prevention device 200 via WIFI, 4G, 3G, satellite, BLUETOOTH, near field technology, radio frequency identification, the Internet, etc., but is not limited thereto.

The mobile device 100 may be any type of mobile device, including, but not limited to, a mobile telephone, a laptop computer, a tablet computer, a palm pilot, a smart-watch, etc.

The mobile device 100 may have running thereupon a program or application (hereinafter, “APP”) that interacts with the mobile device loss prevention device 200. More specifically, when the mobile device loss prevention device 200 is within a certain proximity of the mobile device 100, the APP does nothing. However, if the APP determines (e.g., through GPS calculation or proximity reading) that the mobile device loss prevention device 200 is located at a certain distance from the mobile device 100, such as 20 feet, for example, then the APP causes the mobile device loss prevention device 200 to make a beeping noise, or any other notification selected by the user, in order to alert the user that the mobile device is no longer near the user. The APP can also allow the user to cause the mobile device loss prevention device 200 to play a song or any other type of sound desired by the user.

Alternatively, the mobile device 100 can be paired via BLUETOOTH, for example, with the mobile device loss prevention device 200. When the mobile device loss prevention device 200 is unpaired from the mobile device 100 (i.e., when the mobile device loss prevention device 200 is moved to a distance far away from the mobile device 100), the mobile device loss prevention device 200 may automatically sense the unpairing, thereby initiating the sounds to alert the user that the mobile device 100 is not near the user. In this embodiment, the APP is not necessary, as the BLUETOOTH pairing and unpairing is automatically detected by the mobile device loss prevention device 200.

The mobile device loss prevention device 200 may include a printed circuit board (PCB) 210, a memory 220, a sound shut off button 230, a mobile device finder button 240, a speaker 250, a battery 260, and a keychain 270.

The PCB 210 may include circuitry to communicate with the mobile device 210, such as BLUETOOTH, transmitters, receivers, and a processor, but is not limited thereto.

The memory 220 may include any type of memory to allow various types of audio files having various sounds and/or music to be stored therewithin mobile device loss prevention device 200.

When the mobile device loss prevention device 200 is located at a predetermined distance away from the mobile device 100 (or further than the predetermined distance), then the speaker 250 may play the sound to alert the user that the mobile device 100 is not within proximity of the user.

The sound shut off button 230 may be depressed by the user when the speaker 250 of the mobile device loss prevention device 200 sounds. In other words, it is not preferable for the speaker 250 to continuously play the sound, so the user may depress the sound shut off button 230 to stop the speaker 250 from playing the sound.

The mobile device finder button 240 may be used to send a signal from the PCB 210 to the mobile device 100, in order to control the mobile device 100 to ring or play some type of sound to help the user find the mobile device 100.

The battery 260 may be any type of battery, including rechargeable battery to allow the mobile device loss prevention device 200 to be easily recharged, and may provide power to all the other components of the mobile device loss prevention device 200.

The keychain 270 may be used to allow the user to conveniently keep the mobile device loss prevention device 200 on a keychain of the user.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A mobile device loss prevention system, comprising:
a mobile device; and
a mobile device loss prevention device to communicate with the mobile device, comprising:
a speaker to play a sound in response to the mobile device loss prevention device being moved out of a predetermined range of the mobile device, such that the sound is selected by a user using the mobile device.

2. The mobile device loss prevention system of claim 1, wherein the speaker plays the sound in response to a BLUETOOTH connection between the mobile device loss prevention device and the mobile device is severed.

3. The mobile device loss prevention system of claim 1, wherein the mobile device loss prevention device further comprises:
a sound shut off button to control the speaker to stop playing the sound; and
a mobile device finder button to send a signal to the mobile device to control the mobile device to play a sound.

4. A mobile device loss prevention device, comprising:
a printed circuit board to allow the mobile device loss prevention to communicate with a mobile device; and
a speaker to play a sound in response to the mobile device loss prevention device being moved out of a predetermined range of the mobile device, such that the sound is selected by a user using the mobile device.
